(19) United States
(12) Patent Application Publication
(10) Pub. No.: US 2018/0076875 A1
(43) Pub. Date: Mar. 15, 2018

(54) METHOD AND APPARATUS FOR NON-LINEAR ANTENNA ARRAY ANGLE OF ARRIVAL DETECTION

(71) Applicant: QUALCOMM Incorporated, San Diego, CA (US)

(72) Inventors: Anssi Kaleva HAVERINEN, San Diego, CA (US); Yoshiro FUKUOKA, Solana Beach, CA (US)

(21) Appl. No.: 15/267,076

(22) Filed: Sep. 15, 2016

(51) Int. Cl. H04B 7/08; G01S 3/28

(52) U.S. Cl. CPC H04B 7/086; G01S 3/28

(57) ABSTRACT

Method, device, computer program product, and apparatus to detect an angle of arrival for a wireless signal are described. The wireless signal may be received at a non-linear antenna array and a plurality of candidate angles of arrival for the received signal may be determined. The resulting angle of arrival for the received wireless signal may be determined according to a weighted average of the plurality of candidate angles.

### FIELD

The subject matter disclosed herein relates generally to angle of arrival detection, and more specifically to angle of arrival detection for non-linear antenna arrays.

### BACKGROUND

Radio frequency signals, such as Bluetooth or WiFi signals, received at a device (for example, a mobile device) may be used to estimate which angle the signal is coming from. For example, angle of arrival (AoA) may be measured in three dimensions as part of a process for finding location of another device such as an electronic tag, keyfob, smartwatch, or other device which may broadcast signals. Typical implementations for determining AoA utilize large arrays of antennas which is impractical for portable devices (for example, wearables, mobile phones or other handheld devices) which typically have two antennas which can give a rudimentary AoA. For example, the one antenna may be to receive Bluetooth (BT) signal, while another may be setup to receive WiFi or other signal. With two antennas, a mobile device may determine a general sector location of the signal source but may not be able to determine if the signal source is in front or behind the mobile device. Additionally, two antennas may not be enough to accurately determine any elevation information. Typically, the minimum number of antennas that can be used for 360 degree calculation is three antennas in either “L” or triangle format. However, even with three antennas in a mobile device, solving for angle of arrival of non-linear arrays often entails complicated closed-form functions, involve matrix inversion, and other computationally intensive steps.

### BRIEF DESCRIPTION OF THE DRAWINGS

FIG. 1 is a flow diagram of a method for providing AoA detection, in one embodiment.

FIG. 2 is a diagram of an operating environment for AoA detection, in one embodiment.

FIG. 3 is block diagram illustrating a device to provide AoA detection of signals with a non-linear antenna array, in one embodiment.

FIG. 4 illustrates a uniformly spaced linear array, in one embodiment.

FIG. 5 illustrates a result from Capon, and delay and sum methods using a uniformly-spaced linear array (ULA), in one embodiment.

FIG. 6 illustrates a uniform circular array (UCA), in one embodiment.

FIG. 7A illustrates a uniform triangular array (UTA), in one embodiment.

FIG. 7B illustrates a uniform L-shaped array, in one embodiment.

FIGS. 8, 9, and, 10 represent Capon's solutions for particular subarrays, in one embodiment.

FIG. 11 illustrates the combined Capon's solutions from FIGS. 8, 9, and 10, in one embodiment.

FIG. 12 illustrates a weighted average of the combined estimate of FIG. 11, in one embodiment.

FIG. 13 illustrates a method for AoA detection with majority weighting, in one embodiment.

### BRIEF SUMMARY

Some embodiments discussed herein provide for detecting angle of arrival (AoA) of a wireless signal. In one aspect, a method comprises: receiving the wireless signal at a non-linear antenna array; determining a plurality of candidate angles of arrival for the received signal; and determining a resulting AoA for the received wireless signal based on a weighted average of the plurality of candidate angles.

In another embodiment, a mobile device is configured for AoA detection of a wireless signal and includes memory and a processor configured to: receive the wireless signal at a non-linear antenna array; determine a plurality of candidate angles of arrival for the received signal; and determine a resulting AoA for the received wireless signal based on a weighted average of the plurality of candidate angles.

In another embodiment, a machine readable non-transitory storage medium includes program instructions that are executable by a processor to: receive a wireless signal at a non-linear antenna array; determine a plurality of candidate angles of arrival for the received signal; and determine a resulting AoA for the received wireless signal based on a weighted average of the plurality of candidate angles.

In another embodiment, an apparatus for detecting angle of arrival (AoA) of a wireless signal by a mobile device includes: means for receiving the wireless signal at a non-linear antenna array; means for determining a plurality of candidate angles of arrival for the received signal; and means for determining a resulting AoA for the received wireless signal based on a weighted average of the plurality of candidate angles.

The above and other embodiments, objects, and features of the present disclosure will become apparent from the following description of various embodiments, given in conjunction with the accompanying drawings.

### DESCRIPTION

Reference throughout this specification to “one example”, “one feature”, “an example” or “a feature” means that a particular feature, structure, or characteristic described in connection with the feature and/or example is included in at least one feature and/or example of claimed subject matter. Thus, the appearances of the phrase “in one example,” “an example,” “in one feature,” or “a feature” in various places throughout this specification are not necessarily all referring to the same feature and/or example. Furthermore, the particular features, structures, or characteristics may be combined in one or more examples and/or features.

Angle of arrival (AoA) measurements may be used to determine propagation direction of a radio-frequency (RF) wave incident on an antenna array. Antenna arrays may be arranged in a variety of different configurations. AoA can indicate the direction of an RF wave from the Time Difference of Arrival (TDOA) delays measured at individual elements of the antenna array. AoA for signals received by a linear (also referred to as two dimensional) antenna array may be determined by a number of different methods. For example, Capon's angle and Bartlett's angle are two possible techniques to determine AoA for signals received by a single linear antenna array (for example, a single pair of antennas). In one embodiment, the linear array calculations provided by Capon's angle or Bartlett's angle are leveraged to determine AoA in non-linear (for example, a triangle, circle, “L” shaped, or other multiple dimension) antenna arrays. In one embodiment, an AoA Detection module determines AoA for a non-linear array in response to determining AoA for each of a plurality of linear subarray. Each linear subarray from the non-linear array can be used to compute a candidate AoA resulting in a plurality of candidate angles from the plurality of linear subarrays. In one embodiment, a final (also referred to as a refined, resulting, or output) AoA for the non-linear array is determined by combining the plurality of candidate angles from the plurality of linear subarrays. In some embodiments, the final AoA may be a result of the weighted average of the plurality of candidate angles. The weighted average can include outlier candidate angles weighted by a weight of zero value assigned to outlier candidate angles that are relatively far (for example, outside of a configurable candidate distance threshold) from other candidate angles. In some embodiments, the candidate distance threshold may be determined according to first determining an average of all candidate angles. In some embodiments, pairwise comparisons can be used to identify outlier candidate angles that are too far (according to the candidate distance threshold) from other candidate angles. In one embodiment, candidate angles not meeting the threshold are eliminated (for example, purged or ignored, which may be implemented by setting the respective candidate angle weight to zero). Weights for each of the remaining (for example, not yet eliminated or weighted to zero) candidate angles may be determined according to the distance of the particular candidate angle from an average of all candidate angles.

While traditional methods for determining AoA have focused on direction finding with large antenna arrays or beamforming by tracking multiple targets, AoA detection as described herein may be implemented with minimal antenna array hardware. AoA detection described herein also utilizes minimal computational resources, which may allow for greater flexibility in selecting and designing AoA detection platforms, such as when AoA detection is implemented in mobile and portable devices. The non-linear arrays described herein can include one or more existing mobile device antennae (for example WiFi, LTE, and Bluetooth (BT)) and need not be specialized or dedicated arrays. In some embodiments, utilization of antennas may be shared. For example, a mobile device operating system may utilize an antenna for a first AoA use case (for example, WiFi, LTE, BT, or other utilization) for a set amount of time before switching utilization back to its previous use (for example, WiFi, LTE, BT, or other utilization different than the first).

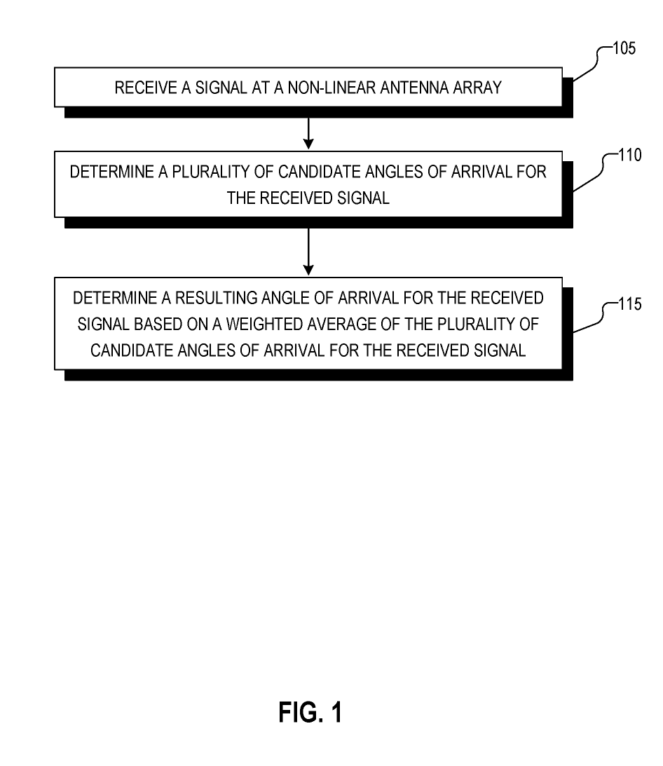

FIG. 1 is a flow diagram of a method for detecting AoA of a wireless signal, in one embodiment. At block 105, a device receives a signal at a non-linear antenna array. For example, the antennas comprising the non-linear antenna array are arranged as one of: circular, triangular, or L-shaped physical non-linear arrangements within a device or locator. In some embodiments, the non-linear antenna array includes three or more linear subarrays.

At block 110, the device determines a plurality of candidate angles of arrival for the received signal. In some embodiments, the plurality of candidate angles of arrival for the received signal comprises a candidate angle determined from each of the linear subarrays of the non-linear antenna array. The one or more of the plurality of candidate angles may be determined according to Capon's angle detection or Bartlett's angle detection methods.

At block 115, the device determines a resulting angle of arrival for the received signal based on a weighted average of the plurality of candidate angles of arrival for the received signal. In some embodiments, candidate angles not meeting a quality threshold are pruned or eliminated from the plurality of candidate angles. For example, the quality threshold may be associated with or determined from one or more of: distance from another candidate angle, an average of a plurality of candidate angles, or a combination thereof. Candidate angles below (i.e., failing to/not meeting) the quality threshold may be weighted to zero or otherwise removed/purged from consideration from a final/resulting AoA. In some embodiments, a weight for each respective candidate angle of the plurality of candidate angles is determined. The weight of the respective candidate angle may be determined according to one or more of: distance from another candidate angle, an average of a plurality of candidate angles, or a combination thereof. As noted above, one or more of the plurality of candidate angles is weighted by a weight of zero in the weighted average of the plurality of candidate angles.

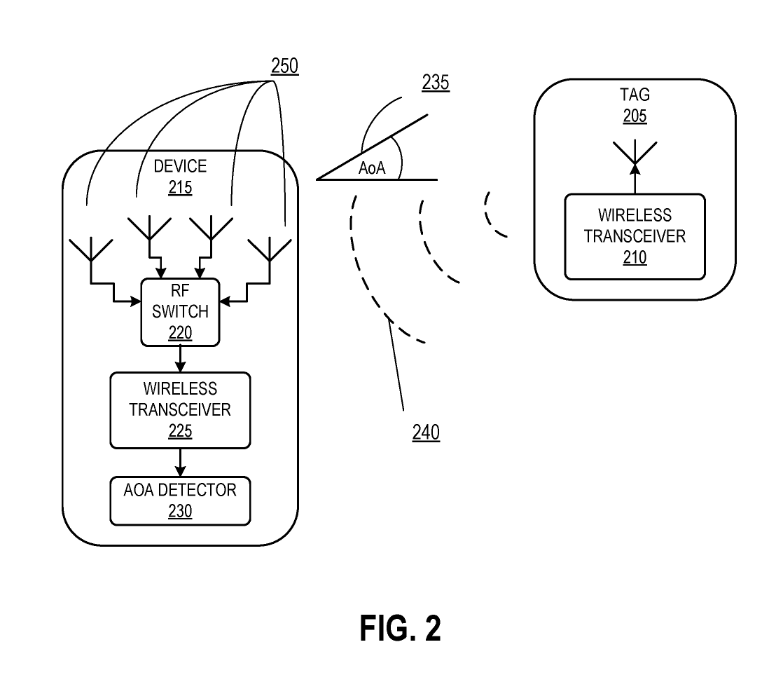

FIG. 2 is a diagram of an operating environment for AoA detection, in one embodiment. Tag 205 may include a wireless transceiver (for example, Bluetooth or WiFi transceiver) to broadcast wireless signals 240, which may be received by device 215 (for example, a signal locator). Wireless signals 240 may be received at device 215 at a given AoA 235. To detect the AoA 235, device 215 may include a Radio Frequency (RF) switch 220, Wireless Transceiver 225, and an AoA Detection module 230 (for example, implemented as a module or engine). In the illustrated example of FIG. 2, device 215 includes an array of antennae 250 and/or Wireless Transceiver 225, which may provide means for receiving the wireless signal at a non-linear antenna array. AoA Detection 230, which can perform the functions described herein, may be implemented in hardware, software, firmware, or any combination thereof. Such an AoA Detection 230 may provide means for determining a plurality of candidate angles of arrival for the received signal, and means for determining a resulting AoA for the received wireless signal based on a weighted average of the plurality of candidate angles. A general purpose computer appropriately programmed in software and/or firmware to perform the methods herein disclosed may also provide means for determining a plurality of candidate angles of arrival for the received signal and means for determining a resulting AoA for the received wireless signal based on a weighted average of the plurality of candidate angles.

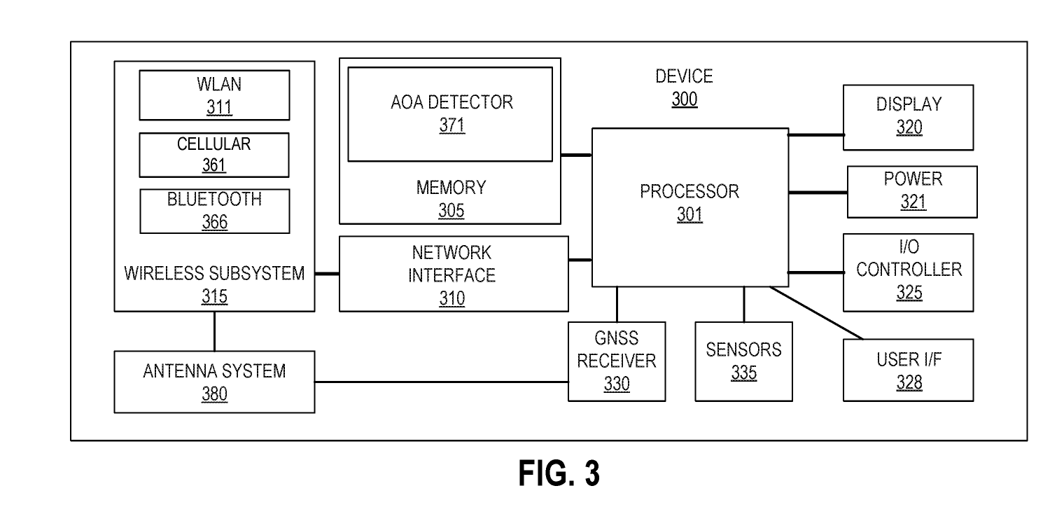

FIG. 3 is block diagram illustrating a device to determine AoA of signals with a non-linear antenna array, in one embodiment. A device capable of determining AoA of signals with a non-linear an antenna array can include an apparatus for position monitoring of a wireless signal transmitter. In some embodiments, device 300 may be a locator or a tag. Device 300 may include one or more processor(s) 301 (for example, a general purpose processor, specialized processor, or digital signal processor), a memory 305, I/O controller 325, and network interface 310. It should be appreciated that device 300 may also include a display 320, a user interface (I/F) 328 (for example, keyboard, touch-screen, or similar devices), a power device 321 (for example, a battery or power supply), as well as other components typically associated with electronic devices. In some embodiments, device 300 may be a mobile or non-mobile device.

The device 300 may also include a number of device sensors 335 coupled to one or more buses or signal lines further coupled to the processor(s) 301. The sensors 335 may include a clock, ambient light sensor (ALS), accelerometer, gyroscope, magnetometer, temperature sensor, barometric pressure sensor, red-green-blue (RGB) color sensor, ultra-violet (UV) sensor, UV-A sensor, UV-B sensor, compass, proximity sensor. The wireless device may also include a Global Positioning System (GPS) or global navigation satellite system (GNSS) receiver 330 which may enable GPS or GNSS measurements in support of A-GNSS positioning. In some embodiments, multiple cameras are integrated or accessible to the wireless device. In some embodiments, other sensors may also have multiple versions or types within a single wireless device.

Memory 305 may be coupled to processor(s) 301 to store instructions (for example, instructions to perform AoA detection 371) for execution by processor(s) 301. In some embodiments, memory 305 is non-transitory. Memory 305 may also store software or firmware instructions (for example, for one or more programs or modules) to implement embodiments described herein, such as AoA detection embodiments described in association with FIG. 1. Thus, the memory 305 is a processor-readable memory and/or a computer-readable memory that stores software code (programming code, instructions, etc.) configured to cause the processor(s) 301 to perform the functions described herein. Alternatively, one or more functions of AoA detection may be performed in whole or in part in device hardware.

Memory 305 may also store data from integrated or external sensors. In addition, memory 305 may store application program interfaces (APIs) for providing access to one or more features of AoA detection as described herein. In some embodiments, AoA detection functionality can be implemented in memory 305. In other embodiments, AoA detection functionality can be implemented as a module separate from other elements in the wireless device 300. The AoA detection module may be wholly or partially implemented by other elements illustrated in FIG. 3, for example in the processor(s) 301 and/or memory 305, or in one or more other elements of the device 300.

Network interface 310 may also be coupled to a number of wireless subsystems 315 (for example, Bluetooth subsystem 366, WLAN subsystem 311, Cellular subsystem 361, or other networks) to transmit and receive data streams through a wireless antenna system 380 to/from a wireless network or through a wired interface for direct connection to networks (for example, the Internet, Ethernet, or other wireline systems). Wireless subsystems 315 may be connected to antenna system 380. Antenna system 380 may be connected to GPS or GNSS receiver 330 to enable reception of GPS or other GNSS signals by GPS or GNSS receiver 330. Antenna system 380 may comprise a single antenna, multiple antennas and/or an antenna array and may include antennas dedicated to receiving and/or transmitting one type of signal (e.g. cellular, WiFi or GNSS signals) and/or may include antennas that are shared for transmission and/or reception of multiple types of signals. WLAN subsystem 311 may comprise suitable devices, hardware, and/or software for communicating with and/or detecting signals from WiFi APs and/or other wireless devices within a network (for example, femtocells). In one aspect, WLAN subsystem 311 may comprise a WiFi (802.11x) communication system suitable for communicating with one or more wireless access points.

Cellular subsystem 361 may include one or more wide area network transceiver(s) that may be connected to one or more antennas in antenna system 380 (for example, in some embodiments the antenna system is also implemented and illustrated in FIG. 2 in association with the antenna array 250 of device 215). In some embodiments, antenna system 380 provides means for receiving a signal at a non-linear antenna array as described herein, for example in regards to FIG. 1 block 105. The wide area network transceivers may comprise suitable devices, hardware, and/or software for communicating with and/or detecting signals to/from other wireless devices within a network. In one aspect, the wide area network transceivers may comprise a code division multiple access (CDMA) communication system suitable for communicating with a CDMA network of wireless base stations; however in other aspects, the wide area network transceivers may support communication with other cellular telephony networks or femtocells, such as, for example, time division multiple access (TDMA), Long-Term Evolution (LTE), Advanced LTE, Wideband Code Division Multiple Access (WCDMA), Universal Mobile Telecommunications System (UMTS), 4G, or Global System for Mobile Communications (GSM). Additionally, any other type of wireless networking technologies may be supported and used by wireless device 300, for example, WiMax (802.16), Ultra Wide Band, ZigBee, wireless USB, etc. A wireless signal emitted by a wireless transmitter in accordance with any of the above mentioned systems (wireless or cellular subsystems) may be received by an antenna array and an AoA may be determined for such wireless signal in accordance with the various embodiments disclosed herein.

The device as used herein (for example, device 300) may be a: RF locator, wireless device, cell phone, personal digital assistant, mobile computer, wearable device (for example, watch, head mounted display, virtual reality glasses, etc.), tablet, personal computer, laptop computer, or any type of device that has wireless capabilities. As used herein, a wireless device may be any portable, or movable device or machine that is configurable to acquire wireless signals transmitted from, and transmit wireless signals to, one or more wireless communication devices or networks. Thus, by way of example but not limitation, the device 300 may include a radio device, a cellular telephone device, a computing device, a personal communication system device, or other like movable wireless communication equipped device, appliance, or machine. The term “device” is also intended to include devices which communicate with a personal navigation device, such as by short-range wireless, infrared, wireline connection, or other connection, regardless of whether satellite signal reception, assistance data reception, and/or position-related processing occurs at the device 300. Also, the term “device” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the wireless device, at a server, or at another wireless device associated with the network. Any operable combination of the above can also be considered a “device” as used herein. Other uses may also be possible. While various examples given in the description below relate to wireless devices, the techniques described herein can be applied to other devices.

The device may communicate wirelessly with a plurality of APs, base stations and/or femtocells using RF signals (for example, 300 MHz, 1900 MHz, 2.4 GHz, 3.6 GHz, and 4.9/5.0 GHz bands) and standardized protocols for the modulation of the RF signals and the exchanging of information. For example, the protocol may be Institute of Electrical and Electronics Engineers (17) 802.11x or 3GPP LTE. By extracting different types of information from the exchanged signals, and utilizing the layout of the network (i.e., the network geometry) the wireless device may determine its position within a predefined reference coordinate system.

It should be appreciated that embodiments of the invention as will be hereinafter described may be implemented through the execution of instructions, for example as stored in the memory 305 or other element, by processor(s) 301 of device 300 and/or other circuitry of device 300 and/or other devices. Particularly, circuitry of device 300, including but not limited to processor(s) 301, may operate under the control of a program, routine, or the execution of instructions to execute methods or processes in accordance with embodiments of the invention. For example, such a program may be implemented in firmware or software (for example, stored in memory 305 and/or other locations) and may be implemented by processors, such as processor(s) 301, and/or other circuitry of device 300. Further, it should be appreciated that the terms processor, microprocessor, circuitry, controller, etc., may refer to any type of logic or circuitry capable of executing logic, commands, instructions, software, firmware, functionality and the like.

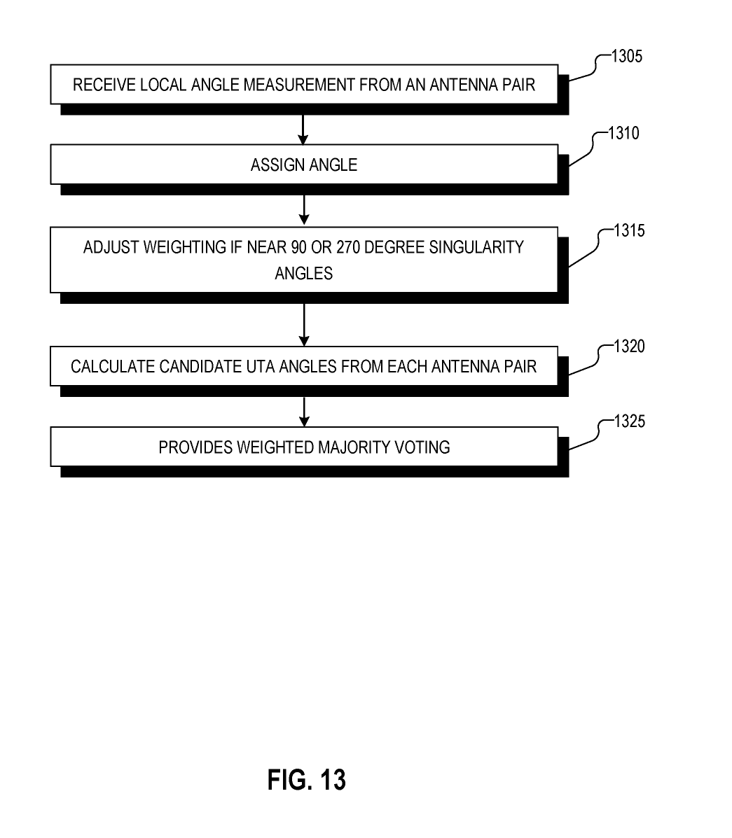

Some or all of the functions, engines or modules described herein (for example, AoA detection features and methods illustrated in at least FIG. 1 and FIG. 13) may be performed by device 300 itself (for example, via instructions of AoA detection module 371 stored in memory 305). In some embodiments or some or all of the functions, engines or modules described herein may be performed by another system connected through I/O controller 325 or network interface 310 (wirelessly or wired) to the device. Thus, some and/or all of the functions may be performed by another system and the results or intermediate calculations may be transferred back to the wireless device. In some embodiments, such other device may comprise a server configured to process information in real time or near real time. In some embodiments, the other device is configured to predetermine the results, for example based on a known configuration of the device. Further, one or more of the elements illustrated in FIG. 3 may be omitted from the device 300. For example, one or more of the sensors 335 may be omitted in some embodiments.

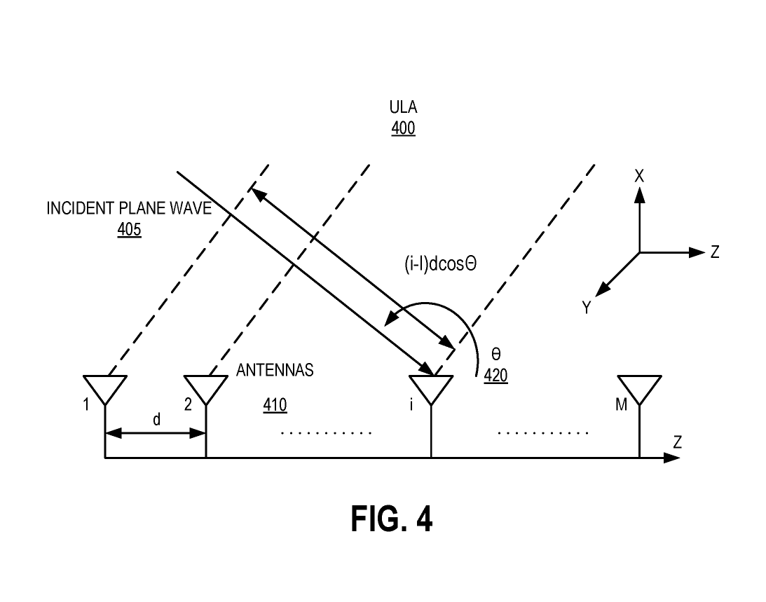

FIG. 4 illustrates a uniformly spaced linear array, in one embodiment. A uniformly spaced linear array (ULA 400) may include “M” antennas 410, typically spaced d=λ/2 apart, where λ equals the wavelength of the received narrowband signal. For example, at 2.4 GHz, the unlicensed band used by Bluetooth and WiFi may be spaced at d=6.25 cm. A ULA can be used to estimate angle θ (for example, illustrated as θ 420) along the z-axis from 0 to π (half-circle). In some embodiments, ULA 400 may not discriminate between θ=0 to π, and θ=π to 2π, or the angles along y-axis and x-axis. Although ULA may be limited in angle discrimination, in some embodiments ULA 400 may be quite small (for example, number of antennas “M” can be as few as two), and θ can be solved with simple calculations. In some embodiments, AoA may be determined with ULA include Delay-and-Sum beamforming, Capon's Minimum Variance, the MUltiple SIgnal Classification (MUSIC) algorithm, the estimation of signal parameters via rotational invariance techniques (ESPRIT) algorithm, and various Maximum Likelihood methods.

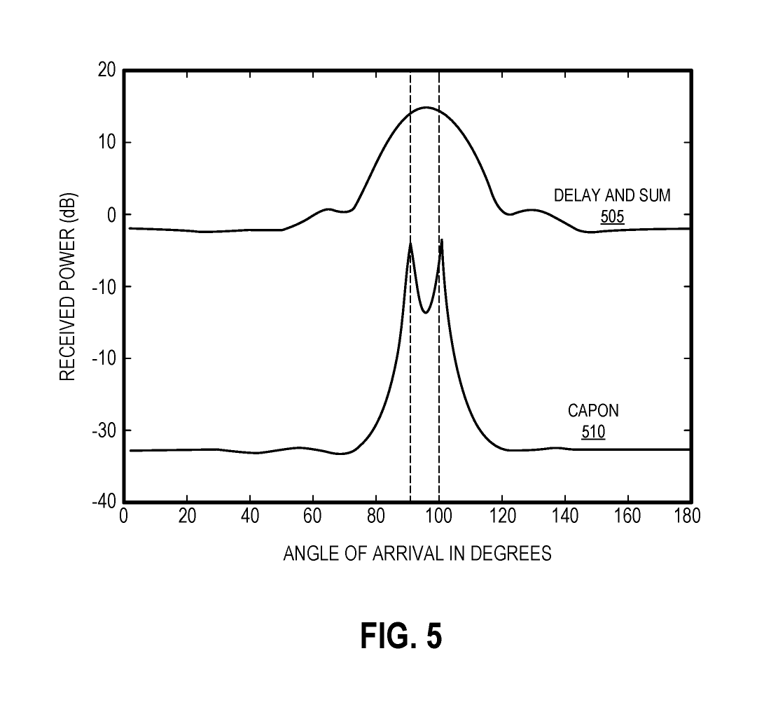

FIG. 5 illustrates an example solution of Capon's method and delay and sum method using a ULA, in one embodiment. The example of FIG. 5 includes a 6-element ULA with two signals arriving at 10 degrees apart. As illustrated in FIG. 5, Capon's method 510 is more efficient than the delay and sum method 505 at resolving multipath. As illustrated in FIG. 5, the AoA can be found at the maxima of the pseudo spectrum. An ULA with an infinitely large M has an operating sector (i.e., field of view) of 180 degrees. Small antenna arrays may have greater uncertainty near 0 and 180 degrees, i.e. a smaller sector where the angle can be discriminated. In some embodiments, when M is above a threshold minimum value, various subspace methods can be used the improve performance with real world non-linearities and with multipath.

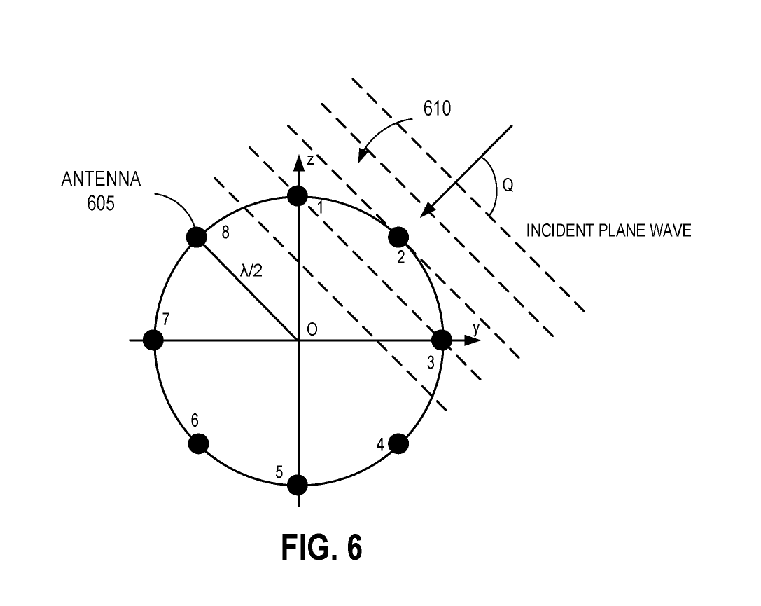

FIG. 6 illustrates a uniform circular array (UCA), in one embodiment. UCA 600 includes M antennas (for example, antenna 605), typically spaced r=λ/2 from origin, where λ equals the wavelength of the received narrowband signal. A minimal UCA is likely to be implemented with a larger hardware footprint than a minimal ULA, and the longest distance between two antennas is λ. A UCA can be used to estimate angle θ along the z and y axes from 0 to 2π (full-circle). The array can also be used to discriminate elevation along x-axis, using subarrays on the z-y-plane. One or more derivations of ESPRIT and MUSIC algorithms may be used to determine AoA. AoA methods for UCA may depend on a large number of antenna elements, and cannot be scaled down to sparse arrays. A UCA is thus less practical than ULA for mobile and portable devices where hardware implementation space is at a premium.

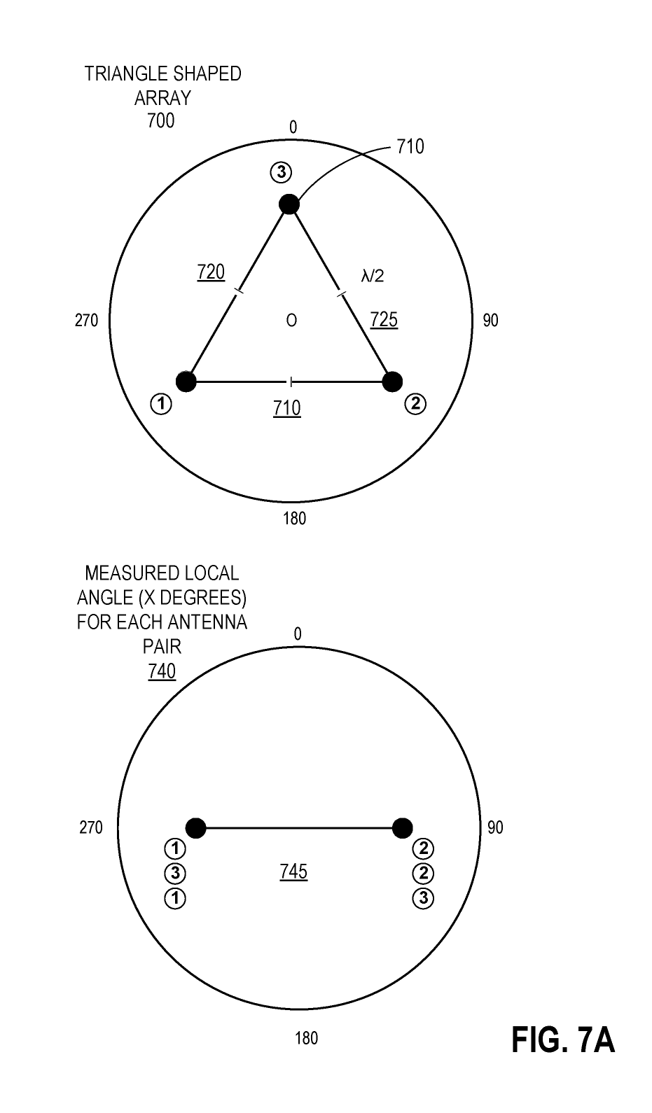

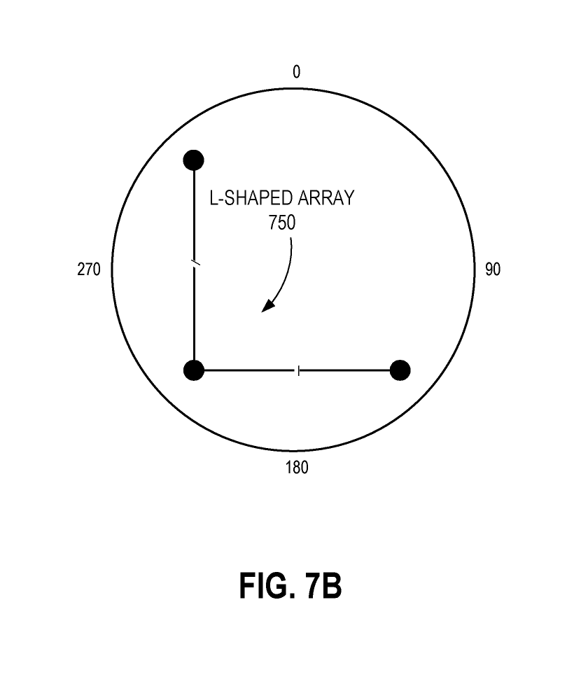

FIG. 7A illustrates a uniform triangular array (UTA), in one embodiment. In embodiments where a compact form factor is desired, a UTA (for example, UTA 700) can provide for a more compact form factor compared to ULA and a UCA described above. For example, UTA 700 can have a 360 degree field of view and can be factorized into three 2-element ULAs for a small hardware footprint and can be utilized with fast and efficient linear area AoA methods. Because the UTA includes three ULAs, the optimal distance between any two antenna elements is λ/2. For example, for a 2.4 GHz band, λ/2=6.25 cm, which fits into small form factor implementations, such as mobile phones. In some embodiments, the arrangement of pairs of ULAs may be expanded to a larger number of elements (such as a square array) by adding the additional antenna and support hardware. Although a single 2-element ULA has a field of view smaller than 180 degrees, and cannot discriminate from front to back, the angle measurements from three ULAs can provide enough overlap to solve the AoA unambiguously. Additionally, elevation angle may be solved as the array is laid in a plane.

FIG. 7B illustrates a uniform L-shaped array, in one embodiment. FIG. 7B illustrates an example L-shaped array 750 in which one or more of the embodiments described herein may be implemented.

As an example of how to solve the UTA angle using Capon's method for each antenna pair, and combining the result, the below MATLAB® notation is provided. Any ULA solution can be applied, but Capon's method for 2 antennas is computationally simple and is therefore an effective example to convey one possible solution for implementing on or more aspects of AoA detection.

Capon's method in MATLAB® notation, in one embodiment:
thetaDeg=linspace(−90,90,180);
thetaRad=thetaDeg*pi/180;
antennaModel=exp(−j*pi*[0:1].′*sin(thetaRad));
Rx=Rx*Rx′; %% Rx is an I/Q array of the received signal
for T=1:180
   % Inverted pseudo spectrum
   S(T)=(antennaModel(:,T)′*inv(Rx*Rx′)*antennaModel(:,T));
end
% Search for the minimum of the inverted pseudo spectrum to solve the received signal angle.
[value,index]=min(S);
CaponAngle=thetaDeg(index);

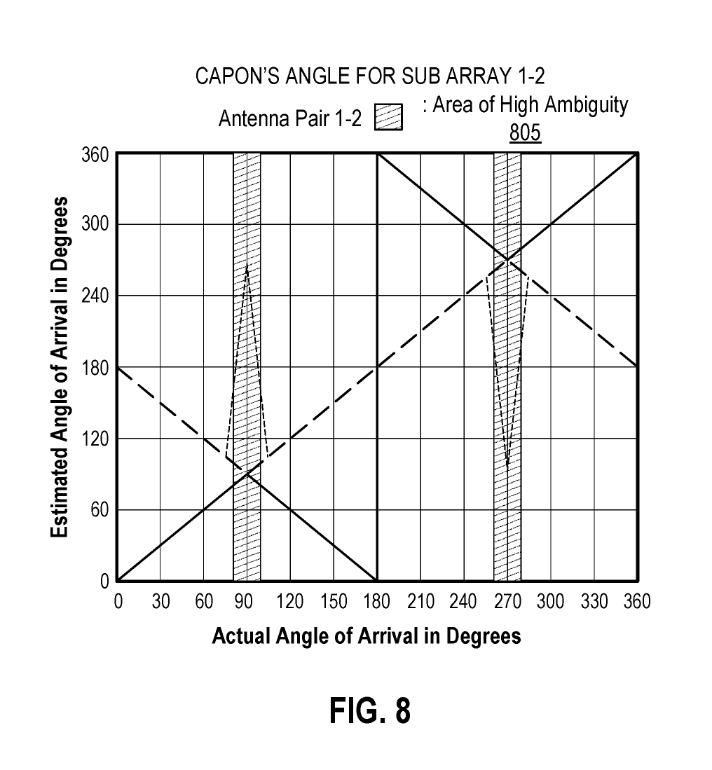

A Capon's solution for the subarray 1-2 is illustrated as FIG. 8. For example, the solution of FIG. 8 may be a result of rotating a single signal source 360 degrees around the UTA with 10 degree steps, high SNR, and no multi path. In some embodiment, a method for AoA detection may include monotonically increasing in front of the subarray and decreasing behind the subarray, with discontinuities at 0 and 180 degrees. A single antenna pair, such as the subarray 1-2 illustrated in FIG. 8, may have potential ambiguity with regards to determining whether the signal is received at a relative front or behind of the device performing the AoA detection. For example, there may be two possible angles assuming that the incoming signal is in the same plane as where the UTA lies. The front/back ambiguity may introduce a sawtooth pattern 805 as illustrated in FIG. 8.

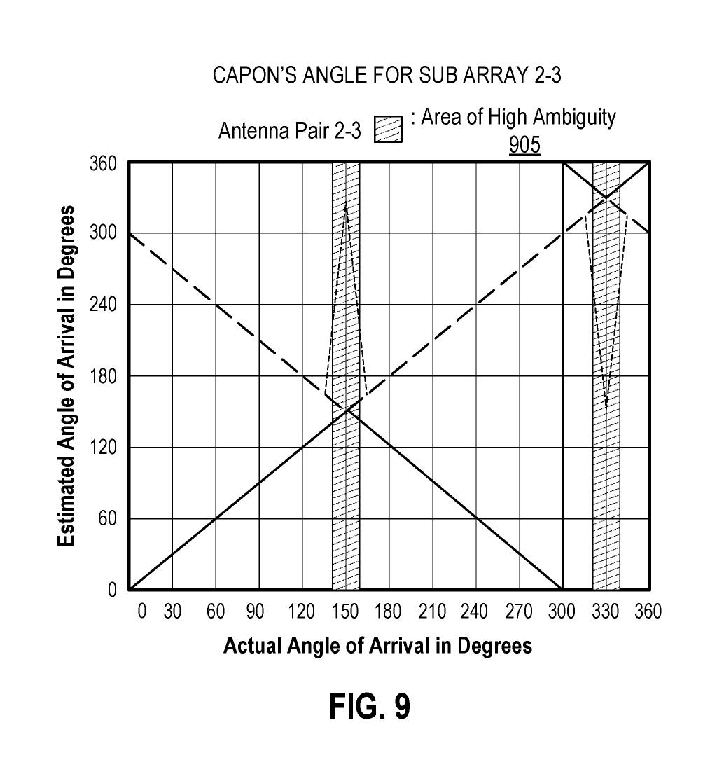

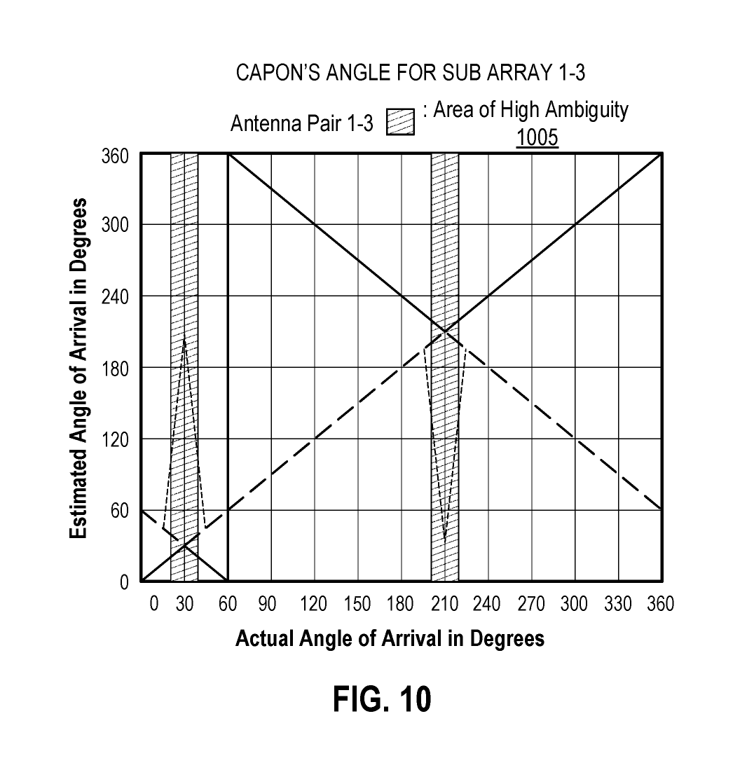

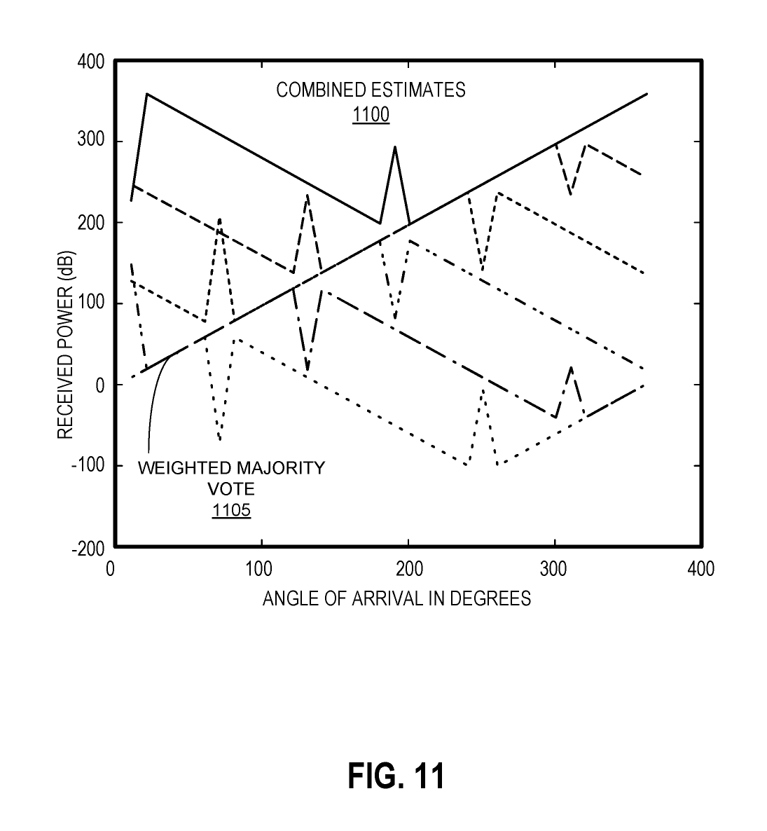

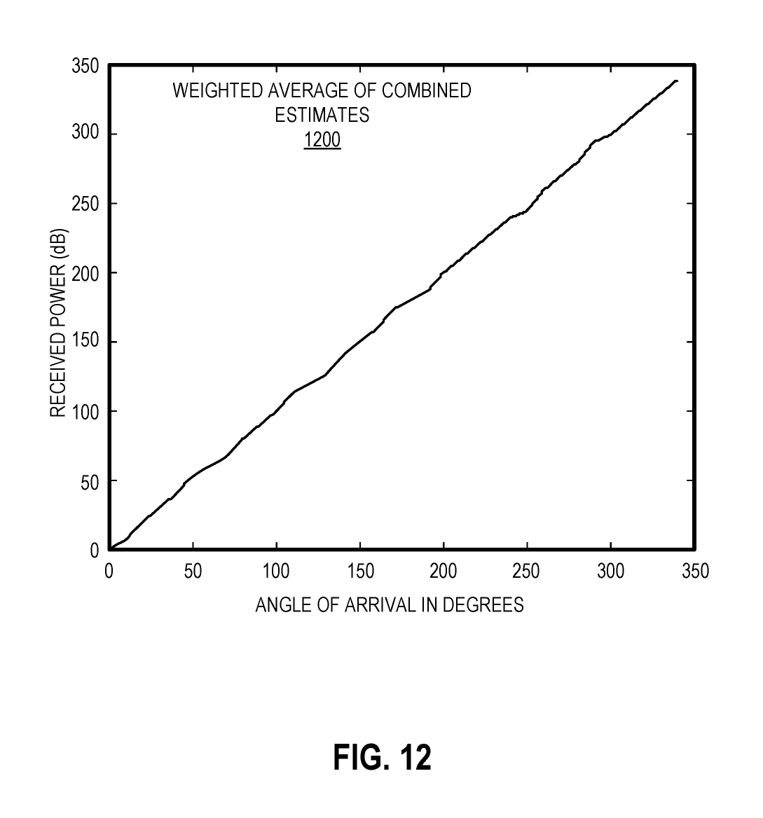

In one embodiment, AoA is solved separately for each of the three subarrays. Although the centerpoints of each subarray do not overlap, in far field situations the origin may be assumed to be at the center of the triangle without introducing a large error to the AoA estimate. The illustrated angles are in a relative 60 degree phase shift, given that the UTA is an equilateral triangle. Capon's solution for subarray 2-3 and subarray 1-3 are illustrated in FIG. 9, and FIG. 10 respectively. Combining the AoA estimates for each subarray and their inverted versions in a single diagram results in the chart of FIG. 11. For example, after inverting the diagrams and shifting of the charts for each subarray, the resulting chart is closer to follow an ideal straight line. The more angle estimates from subarrays that provide approximately the same or close (for example, within a threshold amount) to a particular candidate angle, the higher the probability an accurate AoA will be determined. In some embodiments, multiple consecutive measurements and post processing (for example, a Kalman filter) is leveraged to improve tracking performance. For example, iterative measurements can eliminate or average out the multipath effect and increase the accuracy of a final AoA. In one embodiment, combining the subarrays 1-2, 2-3, and 1-3 introduced above results in the weighted average chart illustrated in FIG. 12.

FIG. 13 illustrates a method for AoA detection with majority weighting, in one embodiment. At block 1305, the method receives a local angle measurement from an antenna pair. For example, a local angle measurement may be determined from antenna pairs in “X” degree measurements. A majority voting process may result in 3 out of 6 AoA measurements being within a threshold distance close to each other, which may result in the most likely candidate angle. Due to the possible discontinuities in the measured angle curve, weighting should be introduced to weigh such discontinuities lower in order to increase the accuracy of the final AoA estimate.

At block 1310, the method assigns angle from a plurality of selected angles. In some embodiments, degrees may be rounded to nearest discrete angle for the purpose of majority voting later (for example, N may be multiplied by 15 degrees, where N=0, 1, 2, . . . etc.).

At block 1315, the method adjusts weight(s) near 90 or 270 degree singularity angles. For example, if a respective “X” degree measurement is within a threshold number/range of degrees from 90 or 270 degree singularity angles, the weight of the respective measurement may be reduced.

At block 1320, the method calculates candidate UTA angles from each antenna pair making up the UTA. In one embodiment, the method calculates two possible UTA angles from each antenna pair. UTA angles may be normalized to within a range of 0 to 360 degrees. For example, “X” and [180−“X”] degrees for antenna pair 1-2 (for example, pair 1-2 as illustrated in FIG. 7A line 710), [“X”+60] and [240−“X”] degrees for antenna pair 3-2 (for example, pair 3-2 as illustrated in FIG. 7A line 725), and [“X”+300] and [120−“X”] degrees for antenna pair 1-3 (for example, pair 1-3 as illustrated in FIG. 7A line 720).

At block 1325, the method provides the weighted majority voting result. For example, the thick line 1105 of FIG. 11 illustrates the weighted majority vote of the angle estimate curves for the subarrays. In this example, the more a single subarray estimate deviates from the others, the less weight it is given in the averaging.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein is for the purpose of describing particular embodiments only and is not intended to be limiting of embodiments of the invention. As used herein, the singular forms “a,” “an,” and “the” are intended to include the plural forms as well, unless the context clearly indicates otherwise. It will be further understood that the terms “comprises,” “comprising,” “includes,” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device (for example, a server or device). It will be recognized that various actions described herein can be performed by specific circuits (for example, application specific integrated circuits), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Those of skill would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in random access memory (RAM), flash memory, read only memory (ROM), erasable programmable read-only memory (EPROM), electrically erasable programmable read-only memory (EEPROM), registers, hard disk, a removable disk, a compact disc read only memory (CD-ROM), digital versatile disc (DVD), or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions or modules described may be implemented in hardware, software, firmware, or any combination thereof. For example, hardware, software, firmware, or any combination thereof may provide means for receiving the wireless signal at a non-linear antenna array, means for determining a plurality of candidate angles of arrival for the received signal, and means for determining a resulting AoA for the received wireless signal based on a weighted average of the plurality of candidate angles.

If implemented in software as a computer program product, the functions or modules may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for detecting angle of arrival (AoA) of a wireless signal, the method comprising:
receiving the wireless signal at a non-linear antenna array;
determining a plurality of candidate angles of arrival for the received signal; and
determining a resulting AoA for the received wireless signal based on a weighted average of the plurality of candidate angles.

2. The method of claim 1, wherein the non-linear antenna array includes three or more linear subarrays.

3. The method of claim 2, wherein the plurality of candidate angles of arrival for the received signal comprises a candidate angle determined from each of the linear subarrays of the non-linear antenna array.

4. The method of claim 1, wherein the antennas comprising the non-linear antenna array are arranged as one of: circular, triangular, or L-shaped physical arrangement within a device.

5. The method of claim 1, wherein one or more of the plurality of candidate angles are determined according to Capon's method, Bartlett's method, or both.

6. The method of claim 1, further comprising:
determining a weight for each respective candidate angle of the plurality of candidate angles, the weight of the respective candidate angle determined according to one or more of:
distance from a candidate angle other than the respective candidate angle,
an average of a plurality of candidate angles, or
a combination thereof.

7. The method of claim 1, wherein one or more of the plurality of candidate angles is weighted by a weight of zero in the weighted average of the plurality of candidate angles.

8. A mobile device for detection of angle of arrival of a wireless signal, the mobile device comprising:
a memory;
a processor coupled to the memory and configured to:
receive the wireless signal at a non-linear antenna array;
determine a plurality of candidate angles of arrival for the received signal; and
determine a resulting AoA for the received wireless signal based on a weighted average of the plurality of candidate angles.

9. The mobile device of claim 8, wherein the non-linear antenna array includes three or more linear subarrays.

10. The mobile device of claim 9, wherein the plurality of candidate angles of arrival for the received signal comprises a candidate angle determined from each of the linear subarrays of the non-linear antenna array.

11. The mobile device of claim 8, wherein the antennas comprising the non-linear antenna array are arranged as one of: circular, triangular, or L-shaped physical arrangement within a device.

12. The mobile device of claim 8, wherein one or more of the plurality of candidate angles are determined according to Capon's or Bartlett's angle detection methods.

13. The mobile device of claim 8, wherein one or more of the plurality of candidate angles has a weight of zero.

14. The mobile device of claim 8, further comprising instructions to:
determine a weight for each respective candidate angle of the plurality of candidate angles, the weight of the respective candidate angle determined according to one or more of:
distance from a candidate angle other than the respective candidate angle,
an average of a plurality of candidate angles, or
a combination thereof.

15. A machine readable non-transitory storage medium having stored therein program instructions that are executable by a processor to:
receive the wireless signal at a non-linear antenna array;
determine a plurality of candidate angles of arrival for the received signal; and
determine a resulting AoA for the received wireless signal based on a weighted average of the plurality of candidate angles.

16. The medium of claim 15, wherein the non-linear antenna array includes three or more linear subarrays.

17. The medium of claim 16, wherein the plurality of candidate angles of arrival for the received signal comprises a candidate angle determined from each of the linear subarrays of the non-linear antenna array.

18. The medium of claim 15, wherein the antennas comprising the non-linear antenna array are arranged as one of: circular, triangular, or L-shaped physical arrangement within a device.

19. The medium of claim 15, wherein one or more of the plurality of candidate angles are determined according to Capon's or Bartlett's angle detection methods.

20. The medium of claim 15, wherein one or more of the plurality of candidate angles has a weight of zero.

21. The medium of claim 15, further comprising instructions to:
determine a weight for each respective candidate angle of the plurality of candidate angles, the weight of the respective candidate angle determined according to one or more of:
distance from a candidate angle other than the respective candidate angle,
an average of a plurality of candidate angles, or
a combination thereof.

22. An apparatus for position monitoring of a wireless signal transmitter, the apparatus comprising:
means for receiving the wireless signal at a non-linear antenna array;
means for determining a plurality of candidate angles of arrival for the received signal; and
means for determining a resulting AoA for the received wireless signal based on a weighted average of the plurality of candidate angles.

23. The apparatus of claim 22, wherein the non-linear antenna array includes three or more linear subarrays.

24. The apparatus of claim 23, wherein the plurality of candidate angles of arrival for the received signal comprises a candidate angle determined from each of the linear subarrays of the non-linear antenna array.

25. The apparatus of claim 22, wherein the antennas comprising the non-linear antenna array are arranged as one of: circular, triangular, or L-shaped physical arrangement within a device.

26. The apparatus of claim 22, wherein one or more of the plurality of candidate angles are determined according to Capon's or Bartlett's angle detection methods.

27. The apparatus of claim 22, wherein one or more of the plurality of candidate angles has a weight of zero.

28. The apparatus of claim 22, further comprising:
determining a weight for each respective candidate angle of the plurality of candidate angles, the weight of the respective candidate angle determined according to one or more of:
distance from a candidate angle other than the respective candidate angle,
an average of a plurality of candidate angles, or
a combination thereof.
